(19) United States
(12) Patent Application Publication
(10) Pub. No.: US 2025/0001290 A1
(43) Pub. Date: Jan. 2, 2025

(54) VIRTUAL ENVIRONMENT NAVIGATION METHOD AND SYSTEM

(71) Applicant: Sony Interactive Entertainment Inc., Tokyo (JP)

(72) Inventors: Mark Anthony, London (GB); Paul Terence Mulligan, London (GB); Jun Yen Leung, London (GB); Christopher William Henderson, London (GB)

(73) Assignee: Sony Interactive Entertainment Inc., Tokyo (JP)

(21) Appl. No.: 18/739,705

(22) Filed: Jun. 11, 2024

(30) Foreign Application Priority Data
Jun. 27, 2023 (GB) 2309675.3

(51) Int. Cl. A63F 13/31; A63F 13/537; A63F 13/77; A63F 13/86

(52) U.S. Cl. CPC A63F 13/31; A63F 13/537; A63F 13/77; A63F 13/86

(57) ABSTRACT

There is provided a method for user navigation of virtual environments across a plurality of devices. The method includes: executing a first instance of a game at a first device, wherein the game comprises a virtual environment comprising one or more interactive elements; receiving data relating to a current state of the first instance; and executing a second instance of the game at least in part based on the received data relating to the current state of the first instance, where at least one of the one or more interactive elements is omitted in a virtual environment of the second instance, and where a user of a second device is able to control navigation of the virtual environment of the second instance

### BACKGROUND OF THE INVENTION

### Field of the Invention

The present invention relates to a method and system for user navigation of virtual environments across a plurality of devices.

### Description of the Prior Art

Modern games often have virtual environments that are very complex and feature rich. In order to complete their objectives in the game (e.g. to complete a mission), users often refer to an in-game map of the environment. Some users also watch videos (e.g. streams or replays) of other users playing the game to observe strategies for playing the game.

However, these aids suffer from several drawbacks. In-game maps are typically displayed in a top down view and at a large scale, which can make it difficult for users to obtain the relevant information needed to assist in completing the objective form these maps. Further, the map typically takes up a most of the display space and users often need to pause the game to view the map. This reduces the interactivity and immersiveness of the game, and can reduce engagement of the user with the game. Users can similarly find it difficult to obtain the relevant information from watching videos of other user's gameplay as the viewpoint or speed of the video may not suit the particular user. Further, interaction between users when watching such videos is typically restricted to text and audio chat, and some users may find it difficult to engage with, or pay attention to, these videos. The present invention seeks to mitigate or alleviate these problems, and to provide techniques for more immersive and interactive navigation of virtual environments.

### SUMMARY OF THE INVENTION

Various aspects and features of the present invention are defined in the appended claims and within the text of the accompanying description and include at least:

In a first aspect, a method for user navigation of virtual environments across a plurality of devices is provided in accordance with claim 1.

In another aspect, a system for user navigation of virtual environments across a plurality of devices is provided in accordance with claim 15.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an entertainment system;

FIG. 2 is a schematic diagram of a user navigation system;

FIG. 3 is a flow diagram of a user navigation method; and

FIG. 4 is a schematic diagram of a further user navigation system.

### DESCRIPTION OF THE EMBODIMENTS

A method and a system for user navigation of virtual environments across a plurality of devices are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

In an example embodiment of the present invention, a suitable system and/or platform for implementing the methods and techniques herein may be an entertainment device such as the Sony® PlayStation 5® videogame console.

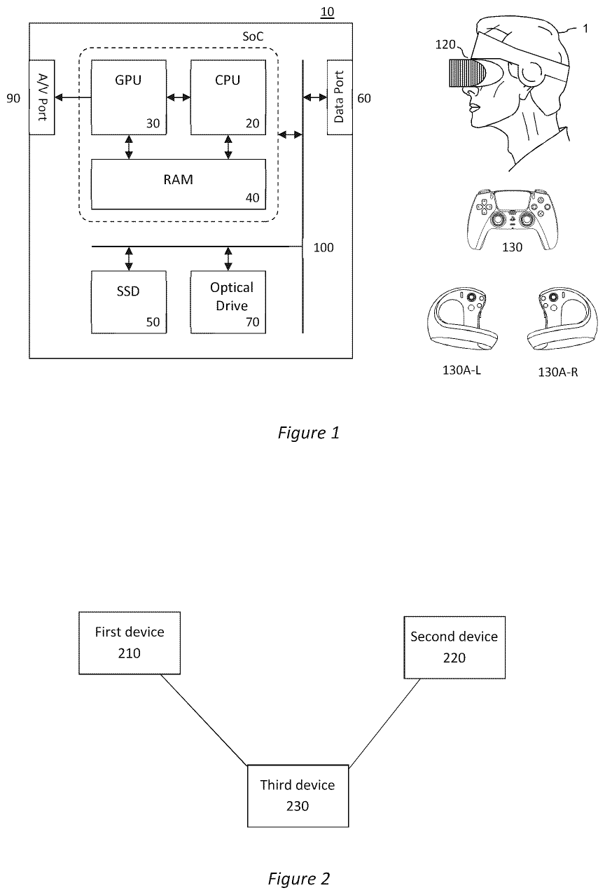

Referring now to the drawings, wherein like reference numerals designate identical or corresponding parts, FIG. 1 shows an example of an entertainment device 10 which is a computer or console such as the Sony® PlayStation 5® (PS5).

The entertainment device 10 comprises a central processor 20. This may be a single or multi core processor, for example comprising eight cores as in the PS5. The entertainment device also comprises a graphical processing unit or GPU 30. The GPU can be physically separate to the CPU, or integrated with the CPU as a system on a chip (SoC) as in the PS5.

The entertainment device also comprises RAM 40, and may either have separate RAM for each of the CPU and GPU, or shared RAM as in the PS5. The or each RAM can be physically separate, or integrated as part of an SoC as in the PS5. Further storage is provided by a disk 50, either as an external or internal hard drive, or as an external solid state drive, or an internal solid state drive as in the PS5.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90, or through one or more of the wired or wireless data ports 60.

An example of a device for displaying images output by the entertainment device is a head mounted display ‘HMD’ 120, such as the PlayStation VR 2 ‘PSVR2’, worn by a user 1. It will be appreciated that the content may be displayed using various other devices—e.g. using a conventional television display connected to A/V ports 90.

Where components are not integrated, they may be connected as appropriate either by a dedicated data link or via a bus 100.

Interaction with the system is typically provided using one or more handheld controllers 130, 130A, such as the DualSense® controller 130 in the case of the PS5, and/or one or more VR controllers 130A-L,R in the case of the HMD. The user typically interacts with the system, and any content displayed by, or virtual environment rendered by the system, by providing inputs via the handheld controllers 130, 130A. For example, when playing a game, the user may navigate around the game virtual environment by providing inputs using the handheld controllers 130, 130A.

Embodiments of the present disclosure relate to methods and systems for user navigation of virtual environments across a plurality of devices. This includes executing a first instance of a game at a first device (such as the entertainment system 10), and executing a second instance of that same game based on data relating to the current state of the first instance, where the second instance and the corresponding virtual environment of the game in the second instance are accessible by a second device (e.g. a user device such as a smartphone) so that the user of the second device can navigate the virtual environment of the second instance.

This provides a more engaging and more immersive way for users to obtain information about the virtual environment and about the first instance. In particular, by executing the second instance based on the current state of the first instance, the second instance and its virtual environment can reflect the first instance and its environment (e.g. as of a particular time point), so that by navigating the virtual environment of the second instance the user can obtain information about the first instance and, e.g., track their progress in the first instance or consider strategies for playing in the first instance. At the same time, because the second instance is executed based on the current state of the first instance and interactive elements are omitted in the second instance, the amount of information provided to the user in the second instance can be controlled to reflect the user's progress in the first instance (e.g. in order to prevent spoilers, or cheating).

Executing separate instances for the first and second devices allows ensuring that the execution of each instance is tailored to the corresponding device. Thus, for example, the second instance can be executed to facilitate navigation of the environment of the second instance using the second device (e.g. to ensure that the environment is generated at an appropriate scale and that appropriate navigation controls are provided). Executing separate instances also allows interaction between users of different types of devices, such as game consoles, personal computers or smartphones.

In addition, by executing the first instance at the first device and making the second instance of the game accessible to the second device, the present disclosure allows providing intuitive information to users via the second device, and without occupying screen space on the first device. In other words, the present invention addresses the problem of the limited screen size of the first device, thus, e.g., allowing users to continue gameplay on the first device whilst being able to simultaneously navigate the virtual environment of the second instance on the second device (e.g. to assess the results of their previous actions or plan future actions in the first instance).

It will be appreciated that while the first and second devices are distinct, the first and second device may be used by the same user or different users. In the first case, a given user may for example use the second device (e.g. a smartphone) as a personal aid for obtaining information about the first instance and its virtual environment. In the latter case, the first and second devices may be used to facilitate the provision of assistance for playing the game between users. For example, the user of the first device (‘first user’) may request assistance from the user of the second device (‘second user’) who can intuitively obtain information about the first instance from the second instance and guide the first user, the second user thus providing assistance to the first user. Alternatively, or in addition, the second user may navigate the environment of the second instance to learn from the first user at their own pace (e.g. to observe in detail how the first user arranged his troops across the map), the second user thus learning from (i.e. receiving assistance from) the first user. By executing two separate instances of the game, and allowing the user of the second device to navigate the environment of the second instance, the user of the second device is provided with more information and can view this information at their own pace as compared to conventional systems were users watch streams or share screens, and thus can provide improved guidance to and/or learn more easily from the user of the first device.

The present disclosure is particularly applicable to games with large and complex virtual environments (such as open world games) that users typically play over multiple sessions. The present disclosure allows users to play the game using the first device, and navigate a copy of the game's virtual environment using the second device—for example in between game sessions using the first device—to track their progress or consider strategies for game play. In some cases, the present disclosure may be particularly applicable for users with learning or memory disabilities, who can use the second instance as a learning or memory aid (e.g. to remind themselves what checkpoint they got to playing in the first instance). Thus, in some cases, the present invention may provide improved accessibility for such users.

It will be appreciated that the term “instance” relates to a copy of the game (i.e. game software) running on a given device or group of devices (e.g. a cloud server) or related software that is operable to generate an interactive virtual environment in accordance with the game. An example of this is a companion application, or a reduced version of the game (such as a version of the game with only single-player functionality and no multiplayer functionality).

It will also be appreciated that the term “virtual environment” relates to the virtual environment generated for a corresponding instance of the game. Accordingly, although the second instance is executed in dependence on data relating to the first instance, the virtual environments of each instance are separate such that changes in one of the virtual environments are not reflected in the other (although in some cases a communication between devices may be performed to allow interactions between the virtual environments). For example, the virtual environment of the second instance may be a copy of the virtual environment of the first instance, e.g. as of a particular time point in the gameplay in the first instance.

FIG. 2 shows an example of a system 200 for user navigation of virtual environments across a plurality of devices in accordance with one or more embodiments of the present disclosure.

The system 200 comprises a first device 210, a second device 220, and a third device 230. As shown via connecting lines in FIG. 2, the first device 210 (e.g. the entertainment device 10) may communicate with the third device 230 (e.g. an external server), and the third device 230 may communicate with the second device 220 (e.g. a mobile/user device, such as a smartphone).

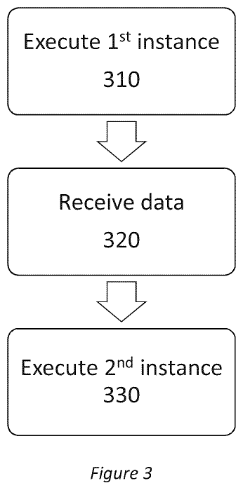

In an example, the first device 210 executes a first instance of a game, so that a user of the first device 210 can navigate and interact with the game's virtual environment in the first instance. The first device 210 then transmits data relating to the current state of the first instance to the third device 230. The third device 230 executes a second instance of the game at least in part based on the received data relating to the current state of the first instance, and makes this second instance accessible to the second device 220 so that a user of the second device 220 can navigate the game's virtual environment in the second instance. Further details of this technique are described with reference to FIG. 3 below.

In an alternative example, the third device 230 may be omitted, and the first device 210 and second device 220 may communicate directly. In this alternative example, the first device 210 may transmit data relating to the current state of the first instance to the second device 220, which may itself execute the second instance of the game. For example, the first and second devices 210, 220 may each be an entertainment system 10.

In some implementations, the third device 230 may execute the first instance of the game in addition to, or instead of, the second instance.

FIG. 3 shows an example of a method for user navigation of virtual environments across a plurality of devices in accordance with one or more embodiments of the present disclosure.

For the purposes of explanation, a non-limiting example of the disclosure may be illustrated with reference to an open world game with a city virtual environment that the user can freely move around and have a range of interactions in. These interactions may be as part of missions or quests in the game, or be separate to any larger mission or quest

A step 310 comprises executing a first instance of a game at the first device 210. The game comprises a virtual environment, which in turn comprises one or more interactive elements.

The user interacts with the virtual environment by interacting with interactive elements in the environment, such as other players, non-player characters (NPCs) or any other relevant objects in the environment (e.g. a car that the user can enter and drive). For example, in the illustrative city virtual environment, the user may interact with NPCs such as pedestrians, or drivers, and other objects such as cars, buildings (which the user can enter), or items such as weapons or potions (which the user can collect or use).

A step 320 comprises receiving data relating to a current state of (the game in) the first instance. This may provide an indication of the current progress of the user of the first device (i.e. ‘first’ user) in the game. As described in further detail below, this data may be used to execute a second instance of the game so that the second instance can reflect the current state of the game in the first instance. This data may be received directly from the first device 210, or via one or more further devices as appropriate.

The data relating to the current state of the first instance may include data relating to one or more of the virtual environment of the first instance, and/or a user of the first device.

Considering data relating to the virtual environment of the first instance, this may include one or more of: an indication of which parts of the environment the first user has access to (e.g. whether the user has unlocked a map extension) and/or has already seen (e.g. which parts the user has already visited), a difficulty level of the game or a subpart (e.g. mission) thereof, a branch of events in the virtual environment followed by the user (e.g. the user may choose one of a plurality of courses of action in the game which each results in a different ‘branch’ of subsequent events in the environment), one or more objects and/or characters in the environment (e.g. different types of enemies the user is fighting in the environment), and/or one or more transient properties of the environment (e.g. the time of day and weather in the environment).

Considering data relating to a user of the first device, this may include one or more of: a location of the user in the environment, a progress of the user in gameplay of the game (e.g. what objectives the user has completed, and/or what checkpoints the user has reached), a level of the user (e.g. a level of the character controlled by the user in the game), one or more items of the user (e.g. one or more weapons of the user), one or more statistics of the user (e.g. a health level of the user), a type of character controlled by the user (e.g. a wizard or archer-type character), a user profile, and/or one or more user settings (e.g. the first user may set how closely the second instance should reflect the first instance).

The data received at step 320 may comprise data relating to the state of the first instance at one or more time points. For example, the data may relate to only the current state of the first instance, or to the current state as well as one or more preceding states (e.g. states leading up to the current state, or states at predetermined time or storyline points in the game). In the latter case, the data relating to preceding states may be used to provide an indication of the progress of the first user in the first instance, e.g. via an animation showing progress between the states (such as a timelapse).

A step 330 comprises executing a second instance of the game at least in part based on the received data relating to the current state of the first instance. The second instance is made accessible to the second device 220, e.g. over an appropriate communication link, so that the user of the second device can navigate the virtual environment of the second instance.

In generating the virtual environment of the second instance, one or more of the interactive elements in the environment of the first instance are omitted. The user of the second device 220 may navigate the virtual environment of the second instances as a ‘ghost’ player or virtual camera, without being able to interact with the environment beyond moving around it. This allows preventing the user of the second device 220 from interacting with interactive elements, e.g. so as to avoid spoilers or cheating. Further, this allows reducing the amount of computational resources required to execute the second instance. Omitting interactive elements in the second instance may comprise omitting/removing the interactive elements, and/or omitting/removing one or more interactive features of these elements. For example, an omitted interactive element may not be rendered at all in the second instance, and/or one or more interactive feature of the element may be omitted—e.g. for an interactive element such as an NPC, interactive features of the NPC may be removed such that the NPC is present in the environment but the user cannot interact with (e.g. speak to, or fight) the NPC.

Executing the second instance and generating a corresponding virtual environment provides an immersive way for users to navigate the environment and allows them to obtain information about the first instance in an engaging and intuitive manner. Further, this immersive and intuitive information sharing is provided in an efficient manner as the second instance omits interactive elements and may, e.g., be rendered at a reduced quality (e.g. lower resolution) and so its execution requires less processing resources than that of the first instance. Thus, a device that has less processing power may be used as the second device 220—for example, the first device 210 may be a games console and the second device 220 may be a smartphone.

It may also be considered advantageous that the second instance is able to be executed by a less powerful device, such as a smartphone, in that this can enable a user to execute the second instance while on-the-go. This can allow a user to interact with the game and plan their next actions in an asynchronous manner; rather than being limited to only obtaining information about the game state while playing the game, a user can execute the second instance at another time. This can allow a user to explore the virtual environment in the second instance (corresponding to the final game state achieved the previous evening) while on the train home from work, so they are prepared to continue their gameplay when they arrive home. This can be performed by transmitting game state information or the like to the second device and then executing the second instance, based upon this transmitted data, at a later time after execution of the first instance has been concluded.

The second instance is executed in such a way as to at least partly reflect the current state of the first instance (e.g. such that the virtual environment of the second instance at least partly reflects the current state of the virtual environment of the first instance). This allows users to obtain information about the first instance by accessing the second instance using a separate, second, device 220, while also controlling the amount of information that is provided to users to prevent spoilers or cheating.

Executing the second instance in dependence on the received data relating to the current state of the first instance may comprise modifying the virtual environment of the second instance (and/or the way in which it is generated), and/or the navigability of the virtual environment of the second instance in dependence on the received data relating to the current state of the first instance. It will be appreciated that the specific he way in which the second instance is executed in dependence on the first instance may depend on the data relating to the current state of the first instance received at step 320.

Considering modifying the virtual environment of the second instance, the virtual environment in the second instance (the ‘second’ virtual environment) may be generated based on received data relating to the virtual environment of the first instance (the ‘first’ virtual environment) and/or to the first user, so that the second environment mimics the first environment and/or is in line with the received user data.

For example, the second environment may be generated to comprise the same objects and/or characters as the first environment, and/or to have the same transient properties (e.g. the same time of day and weather), in order to accurately reflect the current state of the first environment.

Alternatively, or in addition, the components of the second environment that are generated may be dependent on the data received at step 320. For example, based on a received indication of which parts of the first environment the first user has access to and/or has already seen, the second environment may be generated to only comprise those parts of the first environment that the first user has access to and/or has already seen. This allows preventing spoilers and cheating, while also reducing the amount of computational resources needed to execute the second instance and generate the second environment as a smaller second environment may be generated.

Alternatively, or in addition, the second instance may be executed based on the current progress of the first user in the gameplay (e.g. which missions the user has completed). For example, one or more parts of the virtual environment and/or objects therein may be hidden or omitted, or conversely highlighted, in the second instance. This can allow avoiding spoilers. Further, hiding/omitting or highlighting certain objects in the environment can allow directing the attention of the user of the second device 220 to relevant parts of the environment, so as to for example help guide them how to complete a mission—for instance, omitting parts of environment that are not relevant to the mission, or highlighting (e.g. by increasing the brightness of) parts relevant to the mission. The omission or highlighting of objects in the environment may be set based on a predetermined mapping between user progress in the game and objects for omitting or highlighting.

In some cases, generation of the second environment may be dependent on received data relating to user settings. For example, depending on user settings, certain objects (e.g. enemy characters) may be omitted in the second environment, to control the amount of information that can be obtained from, and the degree of assistance provided by, the second environment. It will be appreciated that generation of the second environment may be dependent on user settings of the user of the first and/or second device. For example, when the two users are different, either user may control the amount of information being shared via user settings (e.g. select only part of the first environment for mimicking in the second environment).

Considering navigability of the second environment, the navigability may be modified in dependence on the data received at step 320. The navigability of the second environment by the user of the second device 220 may be varied by modifying one or more of: parts of the environment that the user can move/navigate to (e.g. some parts of the environment may not be accessible to the user), a minimum user incremental motion (i.e. step size) when navigating the environment (e.g. whether the user can move in increments of 1 or 10 m in the virtual environment), a maximum user incremental motion when navigating the environment, a minimum and/or maximum user speed (in the environment) when navigating the environment, a starting position in the environment of the user upon execution of the second instance (e.g. a ‘spawning’ position where the user is spawned), and/or a field of view of the user in the virtual environment (e.g. 360, 180, or 90 degree field of view). The degree of navigability may be modified based on predetermined mappings between data received at step 320 and modifications to the navigability, such as those listed above.

The degree of navigability of the second environment may be varied to make navigation easier or harder for the user of the second device 220. This allows controlling how much information about the first instance can be obtained by the second user by navigating the environment in the second instance. For example, the degree of navigability of the second environment may be varied depending on the difficulty of the game, the level of the user, the profile of the user, and/or user settings.

For instance, if based on user profile data it is determined that the first and second devices 210, 220 are used by the same user, in order to prevent cheating or overreliance on the second instance (e.g. to consider strategies and plan next moves), the navigability of the second environment may be reduced (e.g. by restricting access to some parts of the environment, or increasing the minimum step size). Alternatively, or in addition, if based on the user profile it is determined that the second device 220 is used by a game assistant who's assistance has been requested by the user of the first device 210, then the navigability of the second environment may be increased to allow the game assistant to provide improved advice to the user of the first device (e.g. by allowing access to the entire environment, or decreasing the minimum step size). The navigability of the second environment may similarly be modified based on the difficulty of the game, the level of the user, and/or user settings, to provide for easier to harder navigation of the environment by the user of the second device 220.

In some cases, modifying the navigability may include modifying the spawning position of the user of the second device 220 in the second instance. For example, by default the user of the second device 220 may be spawned at a location corresponding to the current location of the user of the first device 210 in the environment of the first instance as provided by the data received at step 320. In some cases, the user of the second device 220 may be spawned at a different location based on the data received at step 320. For instance, based on received data relating to current progress of the user in the first instance, the user in the second instance may be spawned at a location in the environment that is relevant to that current progress (e.g. the location at which the next mission or sub-mission in the game starts), to provide more relevant information to the user.

The virtual environment of the second instance may be static (i.e. stable and/or at a steady state). The static second virtual environment may reflect (i.e. correspond to) the virtual environment of the first instance as of a particular time point (typically its latest/current state). In some cases, second environment may partially or completely reproduce the first environment as of that particular time point.

It will be appreciated that an environment being “static” relates to the environment being frozen at a particular point in the gameplay of the game. The second environment may comprise static elements (e.g. objects and/or characters in the environment) —however, it will be appreciated that static elements may have corresponding looped animations (e.g. a tree in the virtual environment may be animated to mimic rustling by the wind) that are unrelated to the gameplay. Similarly, NPCs may walk about an environment without any interactions being possible-either with the user, or other elements in the virtual environment.

Executing the second instance with a static virtual environment allows the user of the second device 220 to obtain information about the environment in an intuitive manner as the user is not distracted by any changes to the environment and can observe it as of a particular time point. At the same time, the user cannot directly obtain information about effects of their actions in a static environment (as the environment is stable), and so generating a static environment can prevent providing the user with spoilers and/or cheating by the user. In addition, generating a static environment may require fewer computational resources than generating a dynamic second environment.

In cases where the data received at step 320 comprises data relating to the state of the first instance at a plurality of time points, executing the second instance may comprise generating a plurality of second environments for each corresponding state of the first instance. These environments may be provided to the user of the second device 220. The user of the second device 220 may select one environment for display, and/or switch/flick between environments so as view changes (e.g. in the form of an animation) between the environments (and corresponding states).

The execution of the second instance at step 330 may be performed based on one or more triggers. These triggers can help ensure that the second instance is executed only when required or desired by a user, and so avoid unnecessary use of computational resources. For example, the second instance may be executed in response to a user input/request from the first device 210. In some cases, the second instance may be executed in response to a user input in the first instance of the game—e.g., the user of the first device 210 may make the input in-game. This allows the user of the first device to request execution of the second instance without closing the first instance or stopping game play.

Alternatively, or in addition, the second instance may be executed in response to a user input from the second device 220. In some cases, the second instance may be executed upon opening of an application for accessing the second instance on the second device 220.

In response to user inputs, the user may be provided (on either device) with a selection of which time points to generate an instance for—for instance, the game state may be stored at predetermined intervals (such as every five minutes, or in response to a checkpoint being reached) or in response to user inputs, and a user may be able to select which of these the second instance should correspond to. This can enable a user to use the second instance to identify what has changed between then and the current time in the first instance.

Alternatively, or in addition, the second instance may be executed at predetermined time points (within the ‘real’ and/or virtual environment) and/or predetermined points within the gameplay of the game. For example, the second instance may be executed every 1 hour or 1 day in real or virtual environment time, and/or upon completion of a given or each mission in the game and/or upon the user reaching a predetermined location in the environment. The predetermined time points and/or points within the gameplay may be determined based on user settings received at part of the data received at step 320.

It will be appreciated that in some cases step 320 may be performed based on the same triggers as step 330, such that both steps 320 and 330 are performed only upon the corresponding one or more triggers.

In some implementations, the generation of the second instance may be restricted such that it may only be generated to correspond to historical/previous game/instance states in the first instance. This can enable a user to explore an environment with a further reduced risk of encountering spoilers or obtaining other information that they should not have access to (such as finding the locations of enemies). While enemies can be removed from the second instance to prevent their direct detection, in some cases it may be possible to ascertain their whereabouts based upon contextual clues within the virtual environment.

In some cases, a degree of similarity may be determined between the historical game states and the current game state, e.g. based on the user's progress in gameplay, and/or the objects present in the environment. The generation of the second instance may then be restricted to only historical game states for which the degree of similarity with the current game state is below a predetermined threshold, to further reduce the risk of cheating.

Executing the second instance may comprise rendering the virtual environment of the second instance. In some cases, the virtual environment of the second instance (and corresponding displayed content) may be rendered to a lower quality than the virtual environment of the first instance. This allows reducing the amount of processing resources needed to execute the second instance.

The quality of a virtual environment may include one or more selected from the list consisting of: a frame rate, a graphics quality, and a size of the environment and/or corresponding displayed content. Reducing the graphics quality may include reducing the resolution of the displayed content (e.g. from 1080 pixels per frame to 720 pixels per frame), or reducing any other graphics quality, such as colouring of the pixels (e.g. from displaying images in colour to displaying them in black and white, or with reduced colour depth), or the size of the displayed content (e.g. from filling the entire display to 50% of the display).

Alternatively, or in addition, the frame rate of the displayed content—for example, from 60 frames per second to 30 frames per second—and/or the size of the displayed content may be reduced.

In some cases, executing the second instance at step 330 may at least in part be dependent on one or more properties of the second device 220. In this way, the execution of the second instance may be tailored to the second device 220 to facilitate intuitive navigation of the second environment by the user of the second device 220. Relevant properties of the second device 220 may include one or more of: a type of device, a model of device, an operating system, a screen size and/or resolution, and/or one or more input devices provided with the second device (e.g. touchscreen, mouse and keyboard, or games controller). For example, the navigability of the second environment may be modified in dependence on properties of the device—e.g., the minimum step size for navigation may be modified depending on the input device provided with the second device 220 (e.g. providing a smaller minimum step size for a mouse and keyboard, and a larger minimum step size for a games controller in order to account for the difference in sensitivity to input of these input devices).

It will be appreciated that steps 320 and 330 may be performed at the third device 230, the second device 220, and/or one or more further devices as appropriate.

It will also be appreciated that the second instance at least partly depends on the first instance as it is executed in dependence on data relating to the current state of the first instance. In turn, the first instance may be independent of the second instance—for example, the first instance may be executed independent of the second instance, and the user of the second instance may not be able to interact with the first instance. In this case, events (e.g. user actions) in the second instance may not affect the first instance. In some cases, the first instance may be a standalone instance of the game that is independent of any other instances of the game. This can help prevent cheating by users.

Alternatively, in some examples, the first instance may at least partly depend on the second instance. For instance, the method described with reference to FIG. 3 may further comprise generating one or more visual indicators in the virtual environment of the first instance in response to a user input in the second instance. In some cases, the user input may be provided within the virtual environment of the second instance—e.g. the user may mark one or more points in the second instance of the virtual environment while navigating the environment which can then be viewed while navigating the first instance of the virtual environment. This functionality may be achieved by transmitting data (such as a marker type and in-game location) from the second instance to the first instance, with the first instance being modified accordingly so as to reproduce these markers. This can be performed on-the-fly, such that the markers are added to the first instance immediately, or upon exit of the second instance or input of a command to export markers.

Visual indicators generated in this way may provide a new and more immersive mode of interaction between the first and second instances. For example, the visual indicators generated based on user input in the second instance can be used to guide the user in the first instance—e.g., the user in the second instance (which may be the same as the user in the first instance) can leave clues for themselves or for another user. More broadly, the visual indicators allow the user in the second instance to interact with the user in the first instance, e.g. the user in the second instance may suggest strategies for gameplay to the user in the first instance via the visual indicators.

In some cases, the user input from the second instance may comprise a user selection of one or more points in the virtual environment of the second instance, and generating the visual indicators may comprise generating visual indicators associated with these points in the virtual environment of the first instance, e.g. by generating visual indicators at the corresponding one or more points in the virtual environment of the first instance. For instance, the user in the second instance may select one or more points to indicate locations in the environment that may be of interest to the user in the first instance—e.g. locations they should head to, avoid, or a path they should take across the environment—and the user in the first instance can be guided accordingly using the generated visual indicators. For example, the user may use the second instance to plan a path to follow in the first instance. Alternatively, or in addition, the user in the second instance may select/mark one or more points associated with an object in the environment and corresponding visual indicators may be generated in the environment of the first instance—e.g. the user in the second instance may mark a point of weakness of an enemy in the environment (e.g. a particular body part of the enemy) and a visual indicator may be generated at the corresponding point on the enemy in the first instance to guide the user in the first instance to attack the enemy at that point of weakness.

It will be appreciated that, in a similar manner, visual indicators may also, or alternatively, be generated in the virtual environment of the second instance in response to a user input in the first instance.

In some examples, further interaction between the first and second instances may be provided by enabling sharing of images of the environment between the first and second instances.

For example, the method described above with reference to FIG. 3 may further comprise receiving (e.g. as part of the data received at step 320 and/or separately to that data) an image of the virtual environment of the first instance captured by a user of the first device 210 at a first location in the virtual environment of the first instance, and generating (e.g. as part of executing the second instance or once the second instance is already running) an (visual) indicator (e.g. a pin) associated with the image at the corresponding first location in the virtual environment of the second instance. Upon selection of the indicator by the user of the second device, the associated image may be displayed at the second device 220. The image may, e.g., be a screenshot of the environment taken by the user of the first device 210 while playing the game in the first instance.

Alternatively, or in addition, the method may comprise receiving an image of the virtual environment of the second instance captured by a user of the second device 220 at a second location in the virtual environment of the second instance, and generating an indicator associated with the image at the corresponding second location in the virtual environment of the first instance. Upon selection of the indicator by the user of the first device 210, the associated image may be displayed at the first device.

Indicators generated in this way provide a further mode of interaction between the two instances, and can provide a more interactive and immersive user experience. For example, a user may share their images taken in the first/second instance using the first/second device 210/220 to their (or another user's) second/first device 220/210. In some cases, users may use these images as a learning and/or guidance tool—e.g., the user in the second instance may capture an image of their environment and annotate it in order to provide hints for gameplay to the user in the first instance (e.g. the user may take capture an image of an enemy and annotate its points of weakness).

Further, sharing of images via indicators as described above enables this mode of interaction while also allowing displaying an environment at a large scale. In other words, it allows making more efficient use of the limited screen size by displaying the indicator directly within the virtual environment (and, intuitively, at the corresponding location in the environment), thus allowing the virtual environment to be rendered at a larger scale whilst still allowing sharing of images between instances.

It will be appreciated that the sharing of images in this way may be extended to more than two instances and/or devices such that users can share images between the instances/devices. In some cases, an ‘image sharing’ instance of the game may be executed to which users from other instances can share images they capture and indicators may be generated in the image sharing instance at corresponding locations in the environment. The image sharing instance may be accessible by a plurality of devices. The image sharing instance may allow users to select a top down view of the virtual environment.

In some examples, the method described above with reference to FIG. 3 may further comprise capturing one or more images of the virtual environment of the first instance upon closing of the first instance (e.g. upon receiving a request from the user of the first device 210 to close/terminate the first instance), and providing the one or more images to the second device 220 for display. The one or more images may be captured using a virtual camera (i.e. from a point of view) positioned at the location of the user in the virtual environment of the first instance upon closing of the first instance.

For example, a panoramic (e.g. 360 degree) image of the virtual environment of the first instance may be captured upon closing of the first instance. In some cases, animations of one or more characters (e.g. the user/player controlled character and/or any other characters) in the environment of the first instance may also be captured, and provided to the second device 220 for display.

Providing images captured upon closing of the first instance to the second device 220 allows providing a recap to the second device of the most recent game state in the first instance. For example, users can use the one or more images to remind themselves of where they got to in gameplay in the first instance, which may be particularly beneficial for users who have difficulty with remembering the extent of their previous progress.

In some examples, the method may further comprise generating a model of at least part of the virtual environment of the first instance, and making the model accessible to the second device 220 (e.g. for display and/or navigation thereof at the second device). This can allow the user of the second device 220 to obtain further information about the first instance.

For example, images and/or point clouds may be captured at a plurality of locations in the virtual environment of the first instance, and the model of at least part of the virtual environment of the first instance may be generated based on these images and/or point clouds. The images and/or point clouds may be received as part of the data received at step 320. The model may be generated using appropriate machine learning and/or photogrammetry techniques. In some cases, the images and/or point clouds may be interpolated between locations in the environment. This can allow the user of the second device 220 to more precisely navigate the model of the environment.

It will be appreciated that the techniques described herein may be extended to executing more than two instances of the game. For example, a plurality (e.g. 5 or 100) of further instances may be executed at least in part based on the current state of the first instance, each further instance being accessible to the same device or different devices. In this way, a user may use a plurality of instances and/or a plurality of devices (e.g. their smartphone and personal computer) to track their progress in the first instance—e.g. using each instance and/or device to consider different strategies for playing the game. Alternatively, or in addition, a plurality of users can each use their further device and instance to navigate an environment that mimics that of a first user of the first instance, to observe and/or learn from the first user.

Referring back to FIG. 3, in a summary embodiment of the present invention a method for user navigation of virtual environments across a plurality of devices comprises the following steps. A step 310 comprises executing a first instance of a game at a first device, wherein the game comprises a virtual environment comprising one or more interactive elements, as described elsewhere herein. A step 320 comprises receiving data relating to a current state of the first instance, as described elsewhere herein. A step 330 comprises executing a second instance of the game at least in part based on the received data relating to the current state of the first instance, wherein at least one of the one or more interactive elements is omitted in a virtual environment of the second instance, and wherein a user of a second device is able to control navigation of the virtual environment of the second instance, as described elsewhere herein.

It will be apparent to a person skilled in the art that variations in the above method corresponding to operation of the various embodiments of the method and/or apparatus as described and claimed herein are considered within the scope of the present disclosure, including but not limited to that:
the step 330 of executing the second instance comprises outputting/providing the virtual environment of the second instance to the second device to enable navigation of the virtual environment of the second instance by the user of the second device, as described elsewhere herein;
the second instance is accessible by the second device to enable navigation of the virtual environment of the second instance by a user of the second device, as described elsewhere herein;
the data relating to the current state of the first instance comprises data relating to the virtual environment of the first instance, and/or a user of the first device, as described elsewhere herein;
executing 330 the second instance in dependence on the received data relating to the current state of the first instance comprises modifying the virtual environment of the second instance, and/or the navigability of the virtual environment of the second instance, in dependence on the received data relating to the current state of the first instance, as described elsewhere herein;
the virtual environment of the second instance is static, as described elsewhere herein;
the virtual environment of the second instance corresponds to a current state of the virtual environment of the first instance, as described elsewhere herein;
a user of the first device is the same as the user of the second device, as described elsewhere herein;
executing 330 the second instance comprises executing the second instance at least in part in dependence upon one or more properties of the second device, as described elsewhere herein;
the second instance is executed in response to a user input in the first instance, as described elsewhere herein;
the second instance is executed upon opening of an application for accessing the second instance on the second device, as described elsewhere herein;
the method further comprises: receiving data relating to one or more previous states of the first instance; and receiving a user input selecting, amongst the current state and the one or more previous states, a state of the first instance; wherein executing 330 the second instance comprises executing the second instance at least in part based on the received data relating to the selected state of the first instance, as described elsewhere herein;
in this case, optionally the user input is provided by the user of the first and/or second device, as described elsewhere herein;
the method further comprises generating one or more visual indicators in the virtual environment of the first instance, in response to a user input in the second instance, where the user input comprises a user selection of one or more points in the virtual environment of the second instance; and generating the visual indicators comprises generating visual indicators associated with the one or more points in the virtual environment of the first instance, as described elsewhere herein;
in this case, optionally generating visual indicators associated with the one or more points in the virtual environment of the first instance comprises generating visual indicators at corresponding one or more points in the virtual environment of the first instance, as described elsewhere herein;
the data relating to the current state of the first instance comprises an image of the virtual environment of the first instance captured by a user of the first device at a first location in the virtual environment of the first instance; and executing 330 the second instance comprises generating an indicator associated with the image at the corresponding first location in the virtual environment of the second instance, as described elsewhere herein;
in this case, optionally upon selection of the indicator by the user of the second device, the image is displayed at the second device, as described elsewhere herein;
the method further comprises, upon closing of the first instance, capturing one or more images of the virtual environment of the first instance; and providing the one or more images to the second device for display; where the one or more images are captured using a virtual camera positioned at a location of the user (of the first device) in the virtual environment of the first instance upon closing of the first instance, as described elsewhere herein;
executing 330 the second instance comprises rendering the virtual environment of the second instance, as described elsewhere herein;
in this case, optionally the virtual environment of the second instance is rendered to a lower quality than the virtual environment of the first instance, where the quality of the virtual environment includes one or more selected from the list consisting of: a frame rate, a graphics quality, and a size of the environment and/or corresponding displayed content, as described elsewhere herein;
the data relating to the current state of the first instance comprises images and/or point clouds captured at a plurality of locations in the virtual environment of the first instance; and the method further comprises generating a model of at least part of the virtual environment of the first instance based on the images and/or point clouds, the model being accessible by the second device, as described elsewhere herein;
the second instance at least partly depends on the first instance, and the first instance is independent of the second instance, as described elsewhere herein;
the steps of receiving 320 data and executing 330 the second instance are performed by/at a third device, as described elsewhere herein;
in this case, optionally the third device is a server, as described elsewhere herein;
the steps of receiving 320 data and executing 330 the second instance are performed by/at the second device, as described elsewhere herein; and
the virtual environment is a video game environment, as described elsewhere herein.

It will be appreciated that the above methods may be carried out on conventional hardware suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

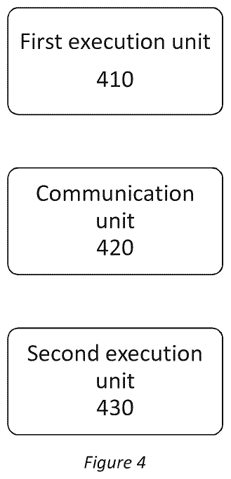

Referring to FIG. 4, in a summary embodiment of the present invention, a system for user navigation of virtual environments across a plurality of devices, may comprise the following:

A first execution unit 410 configured (for example by suitable software instruction) to execute a first instance of a game at a first device, wherein the game comprises a virtual environment comprising one or more interactive elements, as described elsewhere herein.

A communication unit 420 configured (for example by suitable software instruction) to receive data relating to a current state of the first instance, as described elsewhere herein.

A second execution unit 430 configured (for example by suitable software instruction) to execute a second instance of the game at least in part based on the received data relating to the current state of the first instance, wherein at least one of the one or more interactive elements is omitted in a virtual environment of the second instance; and wherein a user of a second device is able to control navigation of the virtual environment of the second instance, as described elsewhere herein.

Of course, the functionality of these units may be realised by any suitable number of processors located at any suitable number of devices and any suitable number of devices as appropriate rather than requiring a one-to-one mapping between the functionality and a device or processor. For example, the first execution unit 410 may be realised by the first device 210, and the communication and second execution units may be realised by the third device 230 and/or the second device 220.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method for user navigation of virtual environments across a plurality of devices, the method comprising:
executing a first instance of a game at a first device, wherein the game comprises a virtual environment comprising one or more interactive elements;
receiving data relating to a current state of the first instance; and
executing a second instance of the game at least in part based on the received data relating to the current state of the first instance, wherein at least one of the one or more interactive elements is omitted in a virtual environment of the second instance, and wherein a user of a second device is able to control navigation of the virtual environment of the second instance.

2. The method of claim 1, wherein the data relating to the current state of the first instance comprises data relating to the virtual environment of the first instance, and/or a user of the first device.

3. The method of claim 1, wherein executing the second instance in dependence on the received data relating to the current state of the first instance comprises modifying the virtual environment of the second instance, and/or the navigability of the virtual environment of the second instance, in dependence on the received data relating to the current state of the first instance.

4. The method of claim 1, wherein the virtual environment of the second instance is static.

5. The method of claim 1, wherein the virtual environment of the second instance corresponds to a current state of the virtual environment of the first instance.

6. The method of claim 1, wherein a user of the first device is the same as the user of the second device.

7. The method of claim 1, wherein executing the second instance comprises executing the second instance at least in part in dependence upon one or more properties of the second device.

8. The method of claim 1, wherein the second instance is executed in response to a user input in the first instance.

9. The method of claim 1, wherein the method further comprises:
receiving data relating to one or more previous states of the first instance; and
receiving a user input selecting, amongst the current state and the one or more previous states, a state of the first instance; and
wherein executing the second instance comprises executing the second instance at least in part based on the received data relating to the selected state of the first instance.

10. The method of claim 1, further comprising generating one or more visual indicators in the virtual environment of the first instance, in response to a user input in the second instance, wherein the user input comprises a user selection of one or more points in the virtual environment of the second instance; and generating the visual indicators comprises generating visual indicators associated with the one or more points in the virtual environment of the first instance.

11. The method of claim 1, wherein the data relating to the current state of the first instance comprises an image of the virtual environment of the first instance captured by a user of the first device at a first location in the virtual environment of the first instance; and wherein executing the second instance comprises generating an indicator associated with the image at the corresponding first location in the virtual environment of the second instance; wherein upon selection of the indicator by the user of the second device, the image is displayed at the second device.

12. The method of claim 1, further comprising, upon closing of the first instance, capturing one or more images of the virtual environment of the first instance; and providing the one or more images to the second device for display; wherein the one or more images are captured using a virtual camera positioned at a location of the user in the virtual environment of the first instance upon closing of the first instance.

13. The method of claim 1, wherein the data relating to the current state of the first instance comprises images and/or point clouds captured at a plurality of locations in the virtual environment of the first instance; and wherein the method further comprises generating a model of at least part of the virtual environment of the first instance based on the images and/or point clouds, the model being accessible by the second device.

14. A non-transitory computer-readable storage medium storing a computer program comprising computer executable instructions adapted to cause a computer system to perform a method for user navigation of virtual environments across a plurality of devices, the method comprising:
executing a first instance of a game at a first device, wherein the game comprises a virtual environment comprising one or more interactive elements;
receiving data relating to a current state of the first instance; and
executing a second instance of the game at least in part based on the received data relating to the current state of the first instance, wherein at least one of the one or more interactive elements is omitted in a virtual environment of the second instance, and wherein a user of a second device is able to control navigation of the virtual environment of the second instance.

15. A system for user navigation of virtual environments across a plurality of devices, the system comprising:
a first execution unit configured to execute a first instance of a game at a first device, wherein the game comprises a virtual environment comprising one or more interactive elements;
a communication unit configured to receive data relating to a current state of the first instance; and
a second execution unit configured to execute a second instance of the game at least in part based on the received data relating to the current state of the first instance, wherein at least one of the one or more interactive elements is omitted in a virtual environment of the second instance; and wherein a user of a second device is able to control navigation of the virtual environment of the second instance.
